(19) United States
(12) Patent Application Publication
(10) Pub. No.: US 2018/0146622 A1
(43) Pub. Date: May 31, 2018

(54) Stem Detector for Crops in a High-Wire Cultivation System

(71) Applicants: Technische Universiteit Eindhoven, Eindhoven (NL); Wageningen Universiteit, Wageningen (NL)

(72) Inventors: Robin Petrus Theodorus Soetens, EINDHOVEN (NL); Marinus Jacobus Gerardus Van de Molengraft, Eindhoven (NL); Sjoerd Van den Dries, Utrecht (NL); Herman Pierre Julien Bruyninckx, Kessel-Lo (BE); Joris Midas IJsselmuiden, Wageningen (NL); Eldert Jan van Henten, Wageningen (NL)

(21) Appl. No.: 15/575,368

(22) PCT Filed: May 19, 2016
(86) PCT No.: PCT/EP2016/061280

§ 371 Date: Nov. 19, 2017

Related U.S. Application Data
(60) Provisional application No. 62/163,767, filed on May 19, 2015.

(51) Int. Cl. A01D 46/30; B25J 13/08; A01D 46/26

(52) U.S. Cl. CPC A01D 46/30; B25J 13/082; A01D 46/264; B25J 13/085

(57) ABSTRACT

A plant detection device is provided that includes a robotic arm having gripping element that includes first and second curved grippers with opposing concave surfaces that move between an open and closed states, and the arm moves and vibrates the gripping element, a proximity force sensor that is disposed on the gripper and outputs a measurement signal of a force between the gripping element and an outgrowth from a stem of a plant under test to a computer, a force and frequency sensor that is orthogonal to the proximity force sensor outputs a gripping force measurement and a frequency response measurement of the stem of the plant under test to the computer, where the computer moves the gripping and vibrating arm according to the sensor signal outputs.

### FIELD OF THE INVENTION

The current invention is directed to automated plant maintenance and harvesting. More specifically, the invention is directed to non-damaging contact sensors and their method of use for robotic plant maintenance.

### BACKGROUND OF THE INVENTION

While the demand for food has gone up tremendously over the past couple of centuries, the amount of people working on farms decreased significantly. Recent surveys show the percentage of farmers, e.g., in the workforce of the US dropped from 41 percent in 1900, to only 1.9 percent in 2000. During the same period of time, the population of the US increased from 76 million people, to 281 million. It is attributed to a huge increase in efficiency of labor in the farming industry that all those people could be fed, with relatively few farmers. Technology for seed- and breeding-control made this happen, but also the direct replacement of human labor in greenhouse and field cultivation with machines.

One example of machines taking over hard work in agriculture can be found in wheat harvesting. Machines called ‘combine harvesters’ exist which are in fact complex semi-autonomous robots. They not only take the wheat from the land, they also thresh it to separate the grain from the plant, and they immediately shred and disperse the unused parts of the plant. Tasks that previously took weeks to complete are now completed in less than an hour by a single person. Far-reaching levels of automation have also been reached for harvesting crops like maize, potato and different kinds of cabbage. These are all crops growing on large fields, for which the plant as a whole can be extracted at harvest time.

For so called ‘high-value crops’ on the other hand, a lower degree of automation has been achieved. Typically, high-value crops like sweet pepper, cucumber and tomato are crops for which the plant stays productive throughout multiple harvesting cycles. Furthermore their fruits are direct end products, as opposed to ingredients to something else. Hence, harvesting needs to be done with great care and at the appropriate time. Often, for high-value crops, only the very first steps in the production process (seeding, grafting etc), and the very last steps (sorting the fruits, packaging etc) are automated, while the steps in between are not. Risk of plant and fruit damage and of harvesting fruits at the wrong stage of maturity is an important reason for that.

What is needed is an automatic solution for plant maintenance that includes the work between seeding/planting and packaging of high-value crops.

### SUMMARY OF THE INVENTION

To address the needs in the art, a plant detection device is provided that includes a robotic arm having an articulating arm and a gripping element, where the gripping element is disposed at a distal end of the articulating arm, where the gripping element includes a first curved gripper and a second curved gripper, where a concave surface of the first curved gripper opposes a concave surface of the second gripper, where the gripping element is configured to move between an open state and a closed state, where the articulating arm is disposed to move and vibrate the gripping element, a proximity force sensor, where the proximity force sensor is disposed on at least one gripper and is connected to the concave surface, where the proximity force sensor is disposed to output a measurement signal to an appropriately programmed computer of a force between the gripping element and an outgrowth of a stem of a plant under test, a force and frequency sensor, where the force and frequency sensor is disposed orthogonal to the proximity force sensor, where the force and frequency sensor outputs to the appropriately programmed computer a gripping force measurement and a frequency response measurement of the plant under test, where the appropriately programmed computer moves the robotic gripping and vibrating arm according to i) the proximity and force sensor output signal, ii) the force and frequency sensor output signal, or iii) the proximity and force sensor output signal and the force and frequency sensor output signal.

According to one aspect of the invention, the proximity and force sensor includes an optical distance sensor in combination with a spring.

In a further aspect of the invention, the force and frequency sensor includes a flexible fiber piezoelectric sensor.

In another aspect of the invention, the force and frequency sensor is disposed orthogonal to the proximity and force sensor.

In a further aspect of the invention, the robotic arm comprises a vibrating robotic arm.

### BRIEF DESCRIPTION OF THE DRAWINGS

FIGS. 1A-1D show different embodiments (1A-1C) for the detector support structure, where the whiskers are connected two by two in order to make sure the stem cannot get to the support structure without touching a whisker, and (1D) the detector connected to the robotic gripping and vibrating arm, according to the current invention.

FIG. 2 shows a schematic drawing of a single bumper element, according to one embodiment of the invention.

FIG. 3 shows a schematic view of an algorithm of determining the force on a bumper, according to one embodiment of the invention.

### DETAILED DESCRIPTION

Touch based fruit and peduncle localization in line with the main-stem paradigm is an unexplored field of research, where once the main stem is acquired and an instrument is connected at the lower parts of the plant, the main stem is followed upward three types of extremities protruding from the main stem can be encountered: 1) side shoots, 2) leaves or stems of leaves, 3) fruit bearing branches. It has the potential to be more robust than vision in a real-world greenhouse scenario, and it could be the enabler to get past single crop single-task use cases. One way or another, to build on the main-stem paradigm a device needs to move along the stem. According to the current invention, a stem detector is provided.

In one embodiment, the invention includes a detector that is configured to switch between plants, where the current invention relates to a guided detector system that is capable of moving along a plant row, switching from one plant to the next.

The current invention is configured to accomplish the following tasks:

1. Position in front of a plant along the greenhouse alley.

2. Find the main-stem.

3. Move along the main-stem, without damaging it.

4. Detect and localize side-branches.

5. Identify whether a branch is a fruit bearing branch, a leaf or a leaf-bearing branch.

For each of the above tasks, a tactile sensor provides the detector with the necessary information. A touch sensor responds to a physical property of the object it is in touch with, different from what the sensor nominally is in touch with. The current invention uses frequency content as well as direct readouts of a signal produced by the touch sensor. More specifically, the invention incorporates touch sensors that measure force or pressure using on-board force sensing using relatively long and flexible structures (i.e., whiskers). Deformation of these hair-like shapes is measured for instance by coating them with strain-sensitive conductors, or by measuring deformation at the clamping point of the whisker. Their flexibility makes that through a whisker typically one can measure relatively low contact forces. At the same time, compared to arrays of direct pressure sensors for instance, they allow to detect objects at a relatively large distance.

To feel the main-stem of a plant while following it, whiskers are used to detect low contact forces at a relatively large distance. In one embodiment, whiskers are a compliant element that allows for the detection of the stem before it touches the rigid part of the manipulator.

For side-branch detection it is desired to be able to localize the point of touch more accurately than a limited set of whiskers can do. With whiskers it is hard to determine where they are touched exactly because a sensed amount of deformation does not map to a unique position. To measure the response of pushing a side-branch, it is desired to measure contact forces larger than what typically falls in the range of a whisker. In one embodiment, a rigid bumper is configured with springs in a suspension system, where by changing the springs in the suspension system one is able to tune the degree to which it is compliant to the side-branch.

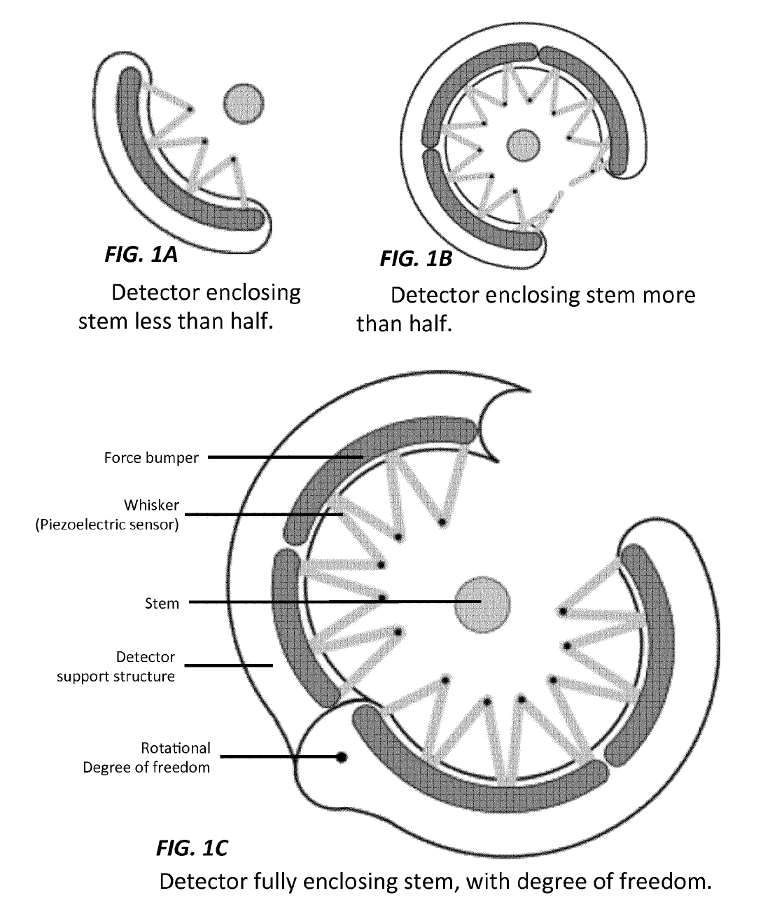

Within the detection plane defined by the bumper a whisker support structure is enabled that fully encloses the stem, or a structure, which encloses all or only part of the stem. In case of the latter, enclosing less than half of the stem implies the whiskers continuously have to stay in touch with the stem in order to be able to follow it. When enclosing more than half of the stem it becomes possible to create a ‘safe zone’ for the stem (compare FIG. 1A to FIG. 1B). When none of the whiskers are touched, the stem is defined to be in the safe zone. With respect to plant damage, the duration and number of touch events should be minimized, where continuously touching the main-stem is not desired.

With respect to side-branch detection, typically there is little prior knowledge of where the side-branch pops out of the main-stem. Therefore it is preferable to enclose the entire stem. Because the detector needs to be able to switch plants, fully enclosing the stem is made possible by providing a detector with internal degree of freedom, according to a further embodiment as shown in FIG. 1C.

FIG. 1D shows the detector connected to a robotic gripping and vibrating arm, according to one embodiment of the invention.

As shown, multiple separate bumper segments are provided, instead of a single bumper covering the entire detector, where a full-scale bumper can localize only a single side-branch at a time. To not harm generalizability towards crops with very little stem between two side-branches, the bumper is segmented. Each segment is supported by at least two springs and equipped with two distance sensors such that both translation and tilt of the segment can be measured.

Regarding the signals interpreted that are input to software, the signal to be processed is represented by the overall whisker deformation and the displacement of the bumper. By associating whisker deformation the invention determines whether or not the whisker is touched. To differentiate between the whisker contacting the plant and mere acceleration of the sensor assembly, a threshold (δ_{w}) is implemented, where if a measured deformation (ρ_{w}) differs more than δ_{w} from its nominal value (ρ_{wn}), the whisker is considered to be touched.

The current invention is configured to account for whisker hysteresis. When fully bent, whiskers will deform elastically, and partly also plastically. The latter stops the whisker from returning to the exact same position as it had before the touch event. Here, a moving average is implemented to compensate for the nominal whisker deformation value over time. The timespan (τ_{wn}) of the moving average ρ_{wn}(t) is relatively small to compensate for hysteresis from one touch event to the next, but relatively large to make sure |ρ_{w}−ρ_{wn}|>δ_{w} for as long as a touch event typically lasts. If τ_{wn} is too small, given a specific touch duration, ρ_{wn}(t) will be compensated both for plastic and elastic deformation. The current invention overcomes uncertainty in when the touch event is over, and when a new touch event begins.

The current invention provides two sensing elements as a stem detector:

(1) Whiskers-like sensors on an inner circumference of the stem detector a shown in FIGS. 1A-1D. These enable the localization of the main stem of a plant with respect to the support structure, while the stem detector moves up or down along the main stem.

(2) A force sensitive bumper on top of the stem detector a shown in FIGS. 1A-1D. These are used to detect and identify a leaf, leaf-stem, side shoots, branches or fruit bearing branches while moving up along the main stem.

In one embodiment, the whiskers include strain gauges on a flexible plastic strip to form ‘flex sensors’. In order to cover the full inner circumference of the detector with a limited amount of whiskers, the whiskers are grouped two by two, forming triangles. From this configuration, the inner circumference of the stem detector doesn't have any numb spots. Once the stem detector surrounds the stem, the stem will actuate at least one whisker as the detector moves along the plant stem.

In a further embodiment, because the empty space within a ‘whisker triangle’ is unutilized, for robustness this space is filled to create touch sensitive ‘fins’.

Some key aspects to the ‘grouped whiskers’ or ‘fins’ are:
1. They are inherently touch-safe for the plant. The force that the tip of the whisker applies to the stem when it is maximally deformed is not enough to damage the plant. The exact force-limit depends on the application.
2. They allow a relatively large distance between the clamping/mounting point of the sensor and the point where the touch event takes place. The relative long span of whiskers/fins (compared to other touch sensors) creates a ‘safety zone’ between the mechanical arm support structure and the main stem. This gives room for error for the external actuation system that moves the stem detector up or down along the main stem. Restated, the plant stem and stem detector are mechanically coupled, where the extremely non-stiff whisker element between the detector and stem enables the main-stem to be used for guidance without damaging it.

Suitable whisker sensing technology is not limited to strain gauges, where the invention includes anything that can measure deformation of a flexible element as the touch sensor. For example, the measuring whisker deformation can be accomplished optically by measuring light intensity along a glass fiber or using an optical tilt sensor at the clamping point of the whisker as applied to the sensor shown in FIG. 1A.

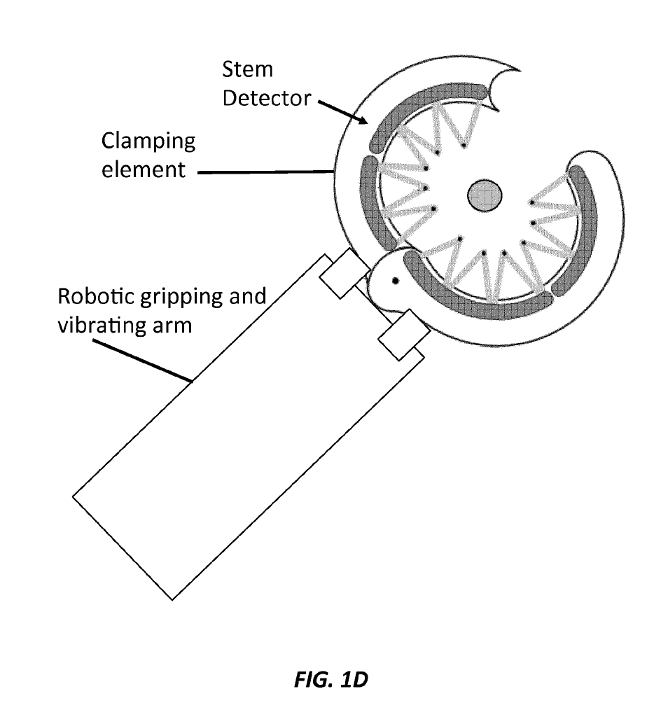

Regarding the force sensing bumper, to measure a force applied by a side-branch blocking the stem detector from moving further up along the main stem the distance of a suspended metal bumper is measured with respect to the support structure. In one embodiment, two optical distance sensors per bumper element are used as shown in FIG. 2.

According to one embodiment, two sensors per bumper are implemented to determine the angle the bumper makes with respect to the support structure, which allows determination of where the bumper is touched exactly.

In further embodiments the sensing bumpers use springs in combination with optical distance sensors, strain resistive sensing technologies, or grids of small pressure sensors derived from thin film technologies.

FIG. 2 shows a schematic drawing of a single bumper element, where relations are available to interpret measurements of the two distance sensors configured underneath the bumper pad, where the sensors can be optical distance sensors, and/or spring force sensors. Through the sensors d₁ and d₂ are measured. Since both distance sensors are at a fixed location with respect to the springs, these are used to obtain the elongation of each spring, which is assumed to translate linearly to the force it imparts on the bumper.

The sum of both forces (F₁+F₂) equals the amount of force with which the peduncle is pushed. In case this force exceeds a predefined threshold, the detector guiding software concludes the detector bumped into a side-branch. Further, the tilt of the bumper segment is used to determine where it is touched exactly. Through the balance of moments at the point of touch F₁l₁=F₂l₂ are determined. Since the fixed distance between both springs (l=l₁+l₂) is known, the point of touch via l₁=F₂l(F₁+F₂)⁻¹ can be determined, where this aspect relates only to when the peduncle touches the part of the bumper between the two springs.

In a further aspect of the invention, the frequency content of the bumper displacement signal is used to detect or identify whether a branch is a fruit bearing branch or a leaf, where a fruit bearing branch clamped at its peduncle tends to dangle at approximately 1.5 Hz. For fruit bearing branches still on the plant the eigenmode is present as well, while for leaves peaks at a lower frequency are found.

According to the current invention, the sensor information is used by the controller in the following manner:
1. The robot moves the stem detector towards a known starting point and grasps the stem, where in one embodiment, a robotic arm moves the stem detector along the main-stem. In another embodiment, a pulley system, or a drone system, moves the stem detector, where the invention includes anything that can move the stem detector in three translational directions and two rotational directions.
2. Since in commercial production systems, plants and thus the main stems are oriented vertically, initially the controller assumes the stem detector has to move straight up in order to follow the stem. While moving, the electrical resistance of each strain gauge (whisker) is compared to a moving average of this value over the last ˜10 sec. In case the difference exceeds a threshold, the controller concludes the whisker is touched and moves the stem detector away from the touch location. In one example, the readouts of the strain gauges were compared to a moving average, as opposed to comparing to a fixed nominal value, because at every touch event the whiskers deform elastically but also plastically. By taking a moving average the plastic deformation was compensated for.
3. While moving upwards, the controller keeps track of touch-events. It logs the xyz position where whiskers are touched in a global coordinate frame, since deviations from a pure vertical position of the main stem do occur. Therefore, after moving along the stem for a while, the controller is able to estimate the local tangent of the stem. This information is used as feedforward in moving the stem detector along the main stem. When no whiskers are touched, the controller will move the stem detector along the estimated tangent. The estimated tangent is also used to tilt the stem detector to keep the plain of the clamping element orthogonal to the main stem.
4. The controller keeps updating the stem tangent estimation based on whisker readouts, and keeps moving the stem detector along the stem tangent, until the force measurement of one of the bumpers exceeds a threshold (i.e., it bumped into a side branch). When that happens the controller stops moving along the estimated tangent and compares the readouts of the two optical distance sensors within the bumper segment to determine where the side branch is exactly.
5. In order to identify the side-branch (i.e., determine whether it's leaf- or a fruit-bearing) the controller moves the stem detector slightly in the direction orthogonal to the side-branch, giving it an initial push to reveal its dynamic properties.
6. The controller logs the readout of the force sensor closest to the side branch for ˜10 sec and calculates spectral density. Since it is known what frequency to look for in a certain fruit or leaf, a threshold on power around this frequency determines whether the controller recognizes the side branch as a leaf or as a fruit.

In one example, bumping into the peduncle of a truss tomato provides a relatively strong 1.9 Hz frequency through the force sensitive bumper of the stem detector. For a leaf instead of the peduncle of a truss a lower frequency is dominant.

According to another aspect of the invention, the appropriately programmed computer assesses the frequency response for a side branch or peduncle of the tomato plant under test, where the first frequency response is in a range of 1 Hz to 2 Hz.

In yet another aspect of the invention, the appropriately programmed computer assesses the frequency response for a leaf of the tomato plant under test, where the second frequency response is in a range of 0.1 Hz to 1 Hz.

According to another embodiment, the appropriately programmed computer assesses the frequency response for the stem of the tomato plant under test, where the first frequency response is in a range of 1 Hz to 10 Hz.

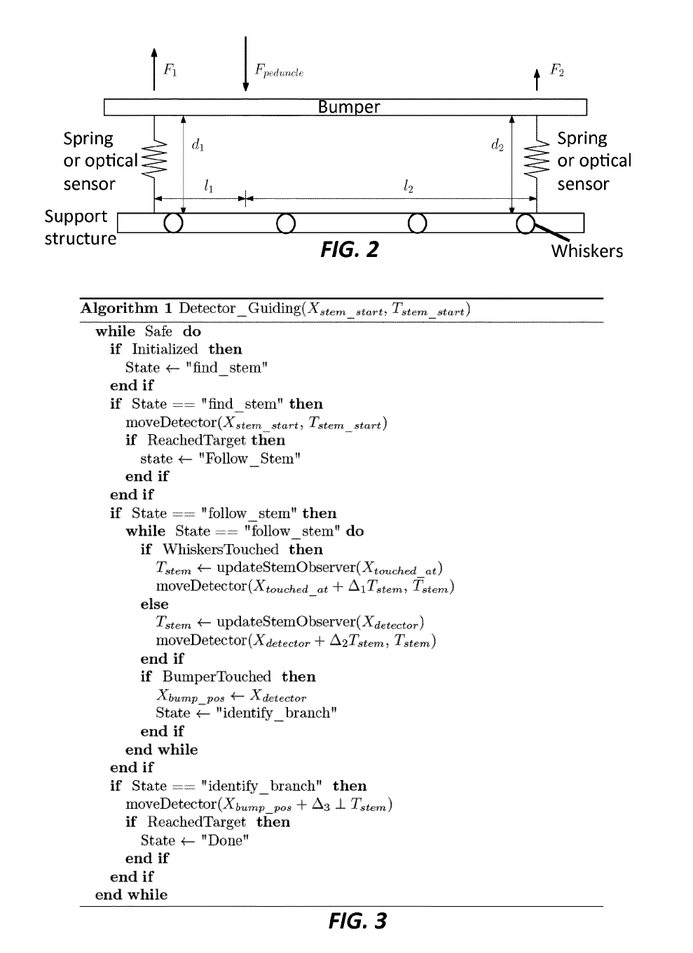

On its highest level, FIG. 3 shows the algorithm for the detector setpoint-generation and guiding, which is a state machine based on the five tasks defined above. As viewed from a global frame, first it directs the detector to a fixed preposition Xₚᵣₑₚₒₛ, where it initializes. Next, it moves to a given point at which it encloses the stem X stem start, and, optionally, for which it knows the tangent of the stem Tₛₜₑₘ_{_}ₛₜₐᵣₜ. If an initial stem tangent is not provided it will assume the stem to be vertical at Xₛₜₑₘ_{_}ₛₜₐᵣₜ. From the stem tracking start position, it moves the detector along the stem while avoiding contact, until it bumps into a side-branch. Lastly, it moves slightly sideways, as an initial push to unveil eigenmodes with respect to the side-branch, as shown in FIG. 3.

Regarding the stem-observer, in a global 3D frame, this module keeps track of where the stem has been acquired, either by touching it or by knowing it to be in the safe zone of the detector. A model of the stem is used that includes a linear fit through the last n centimeters of the stem being kept track of. This knowledge is used to make sure the plane of the detector stays orthogonal to the stem, and, when none of the whiskers are touched, to update the cartesian setpoint of the detector to an extrapolation of the estimated stem tangent.

According to one embodiment, a support structure for the detector is implemented, which can be mounted on a robotic gripping and vibrating arm, according to one embodiment of the invention.

In a further embodiment, the whisker sensor includes an oblong plastic substrate with a thin conductive track on top. This track starts at one end of the substrate then goes to the other end and comes back. Since the track comprises a material whose electrical resistance strongly depends on strain, such flex sensors are prefab whisker shapes with a strain gauge on top.

In an exemplary experiment, the tuning of the whisker thresholds resulted in τ_{wn}=3 seconds and δ_{w}=0.035, with respect to normalized whisker measurements −1<ρ_{w}<1. In one embodiment, two distance sensors are disposed at each segment, where the distance sensors are optical sensors.

Through the command ‘moveDetector( )’ the software passes a cartesian setpoint and desired pose for the detector to the control of the guider, which translates to actuation.

In a further aspect of the invention, the plant detection device is configured to harvest fruits and vegetables, where a cutting or harvesting tool is implement to the detector system, also referred to as an effector, where the detector is configured to cut a fruit-bearing side-branch.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example variations in sensing principles used both for the device that encircles the main stem as well as the device that is used for detection of side branches, leaves and fruit bearing branches. Variations also include the different types of crops to which this system can be applied.

All such variations are considered to be within the scope and spirit of the present invention as defined by the following claims and their legal equivalents.

What is claimed:

1) A plant detection device, comprising:
a) a robotic arm comprising an articulating arm and a gripping element, wherein said gripping element is disposed at a distal end of said articulating arm, wherein said gripping element comprises a first curved gripper and a second curved gripper, wherein a concave surface of said first curved gripper opposes a concave surface of said second gripper, wherein said gripping element is configured to move between an open state and a closed state, wherein said articulating arm is disposed to move and vibrate said gripping element;
b) a proximity force sensor, wherein said proximity force sensor is disposed on at least one said gripper and is connected to said concave surface, wherein said proximity force sensor is disposed to output a measurement signal to an appropriately programmed computer of a force between said gripping element and a stem of a plant under test;
c) a force and frequency sensor, wherein said force and frequency sensor is orthogonal to said proximity force sensor, wherein said force and frequency sensor outputs to said appropriately programmed computer a gripping force measurement and a frequency response measurement of said plant under test, wherein said appropriately programmed computer moves said robotic arm according to i) said proximity and force sensor output signal, ii) said force and frequency sensor output signal, or iii) said proximity and force sensor output signal and said force and frequency sensor output signal.

2) The plant detection device of claim 1, wherein said proximity and force sensor is selected from the group consisting of an optical sensor and a spring sensor.

3) The plant detection device of claim 1, wherein said force and frequency sensor comprises a flexible fiber piezoelectric sensor.

4) The plant detection device of claim 1, wherein said force and frequency sensor is disposed orthogonal to said proximity and force sensor.

5) The plant detection device of claim 1, wherein said robotic arm comprises a vibrating robotic arm.
